(19) United States
(12) Patent Application Publication
(10) Pub. No.: US 2008/0309645 A1
(43) Pub. Date: Dec. 18, 2008

(54) MOBILE ELECTRONIC DEVICE

(75) Inventor: Feng-Jen Wang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/763,642

(22) Filed: Jun. 15, 2007

(51) Int. Cl. G06F 3/033

(52) U.S. Cl. 345/179

(57) ABSTRACT

A mobile electronic device includes a display module and a location module which is separable from the display module. The mobile electronic device utilizes a stylus and ultrasonic transducers arranged in the location module and the stylus to locate the stylus. The display module can be a bi-stable display module having at least one input communication module transmitting the location signal of the stylus to the location module. The location module has at least one output communication unit for disposing the location signal and then displaying the script on the display module. The output communication unit of the location module can be wireless communication unit applying GPRS, or EDGE, or 3G communication treaty, so the location module can communicate with the mobile station and become a mobile communication device.

### BACKGROUND OF THE INVENTION

1. Field of the Invention

The present invention relates to a mobile electronic device, and more particularly to a portable wireless communication device, which displays information on a bi-stable display by a handwriting module.

2. The Related Art

Recently, mobile electronic devices, such as a mobile phone, a PDA (personal digital assistant), a media player, a PND (Portable Navigation Device) etc., are popular in people's life. The mobile electronic device is communicated with people by human sound, keyboard, MFB (multi-functional button), or a handwriting module. In these communication ways, human sound is the most convenient way, for it is in accordance with the communication habit of people. However, the human sound is different from every person and every place, the technology of controlling the mobile electronic device by human sound command is undeveloped. It's common for people to communicate with computer by keyboard, when the keyboard is used to control the mobile electronic device, the volume of the mobile electronic device is become smaller and smaller, so the key of the keyboard is too small and it's inconvenient for people to operate. As a result, a MFB is utilized in mobile electronic device for decrease the number of keys, however, when people hasn't operated the mobile electronic device for a long time, or people has several different mobile electronic devices with different MFBs, it's liable to be confused of the different usage of different MFBs, consequently, the communication between the people and the mobile electronic device is still inconvenient.

Then a handwriting module is utilized to communicate people with mobile electronic device with the technology of OCR (Optical Character Recognition) applied in, thereby, characters are written and inputted into the mobile electronic device. A touch panel is often used in the portable mobile electronic device because the technology is developed and the cost is low, the touch panel is made up of substrate, spacer and film, and made by printing, etching, rinsing and sticking. However, the film is usually scraped unintentionally or separated as a result of the change of the material, moreover, the character sometimes is hard to recognized through the film because of light refraction, as a result, the touch panel has many disadvantages though it is convenient to input the character by handwriting.

FIG. 1 shows a conventional PDA. The panel 11 includes a LCD (Liquid Crystal Display), a touch panel is stuck on the LCD, so the panel is not only a LCD but also a touch panel, people write on the panel directly with a stylus 12, so it's convenient to input characters and edit document. However, the panel consisting of a LCD and a touch panel needs to be changed if either the LCD or the touch panel is damaged, moreover, the LCD consumes much power, when the power is off, the LCD is turned off at the same time, so it often needs to be charged. In a word, the conventional PDA isn't in accordance with the traditional habits of reading and writing.

### SUMMARY OF THE INVENTION

Accordingly, an object of the present invention is to provide a mobile electronic device, comprising a stylus having an ultrasonic transducer near the pen nib, a location module and a bi-stable display module. The location module has a CPU, at least two ultrasonic transducers and at least one output communication unit all electrically connected to the CPU, the two ultrasonic transducers cooperate with the ultrasonic transducer of the stylus to locate the stylus. The location signal is disposed in the CPU and then transmitted outside through the output communication unit. The bi-stable display module has a display driver, a bi-stable display, an image buffer and an input communication unit. The input communication unit receives the location signal transmitted from the location module and then transmits it to the display driver, the location signal is disposed in the display driver and then stored in the image buffer or displayed on the bi-stable display.

Another object of the present invention is to provide a mobile electronic device, comprising a stylus having an ultrasonic transducer near the pen nib, a location module and a bi-stable module. The location module has a CPU, at least two ultrasonic transducers and at least one output communication unit all electrically connected to the CPU, the two ultrasonic transducers cooperate with the ultrasonic transducer of the stylus to locate the stylus. The location signal is disposed in the CPU and then transmitted outside through the output communication unit. The bi-stable display module has a display driver, a bi-stable display, and an input communication unit, the input communication unit receives the location signal transmitted from the location module and then transmits it to the display driver, the location signal is disposed in the display driver and then displayed on the bi-stable display.

A further object of the present invention is to provide a mobile electronic device, comprising a stylus having an ultrasonic transducer near the pen nib, a location module and a bi-stable module. The location module has a CPU, at least two ultrasonic transducers, a storage and a wireless communication unit all electrically connected to the CPU. The wireless communication unit applies GPRS, or EDGE, or 3G communication treaty therein, the two ultrasonic transducers cooperate with the ultrasonic transducer of the stylus to locate the stylus. The location signal is disposed in the CPU and then is transmitted outside through the wireless communication unit. The bi-stable display module has a display driver, a bi-stable display and an input communication unit. the input communication unit receives the location signal transmitted from the location module and then transmits it to the display driver, the location signal is disposed in the display driver and then displayed on the bi-stable display.

As described above, the present invention realizes the communication between the location module, the display module, the far end network and the database in wireless or wire way, a bi-stable display which do not consume much power is used to become an e-book or an e-newspaper, or a projector is used to display the image received from the location module, so the present invention has various applications and is convenient for operating.

### BRIEF DESCRIPTION OF THE DRAWINGS

The present invention will be apparent to those skilled in the art by reading the following description of a preferred embodiment thereof, with reference to the attached drawings, in which:

FIG. 1 shows a conventional PDA;

FIG. 2 is a perspective view of a mobile electronic device of the present invention, having a location module, a stylus, a display module and an input module;

FIG. 3 is a perspective view of the mobile electronic device shown in FIG. 2, showing the location module separated from the display module;

FIG. 4A is a perspective view of a tenon having a protuberance at the front end;

FIG. 4B is a perspective view of another tenon having two separating portions;

FIG. 5 shows the location module clipping papers with the tenon shown in FIG. 4B;

FIG. 6 is a block diagram schematically illustrating the location module according to the present invention;

FIG. 7 is a block diagram schematically illustrating a bi-stable display communicating with a wireless communication unit of the location module by a wireless communication unit for transmitting image signal;

FIG. 8 is a block diagram schematically illustrating the mobile electronic device of the present invention exchanging information by way of USB;

FIG. 9 is a block diagram schematically illustrating the location module connected to a projector and outputting the image to the projector;

FIG. 10 is a block diagram schematically illustrating a media player unit arranged in the location module playing music;

FIG. 11 is a block diagram schematically illustrating the BlueTooth unit communicating with a computer and the computer communicating with Internet; and

FIG. 12 is a block diagram schematically illustrating the wireless communication unit communicating with Internet directly through WiFi or WiMax.

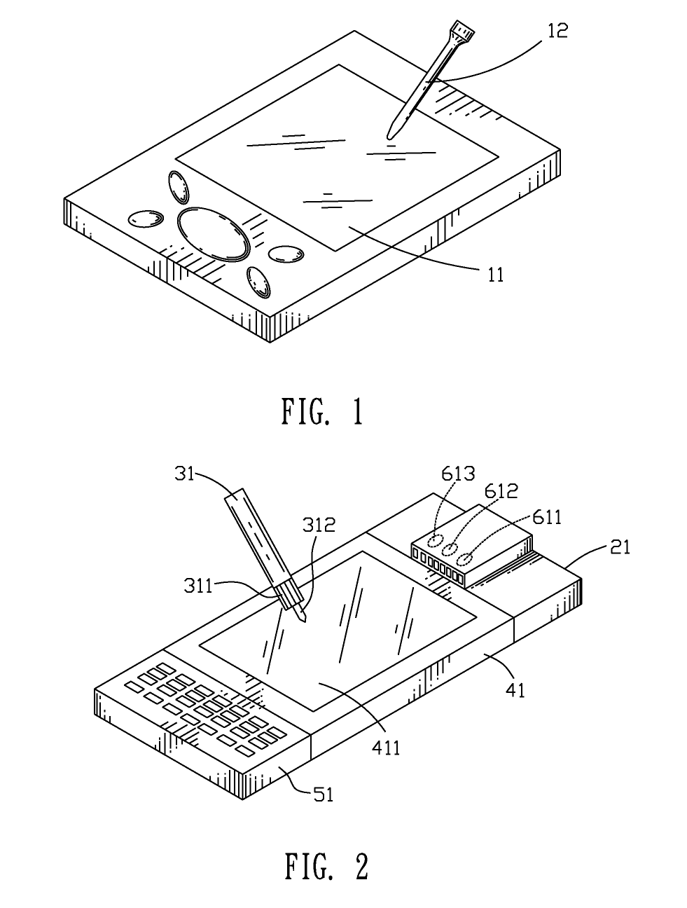

### DETAILED DESCRIPTION OF THE PREFERRED EMBODIMENTS

Please refer to FIG. 2, a mobile electronic device of the present invention includes a location module 21, a stylus 31, a display module 41 and a keyboard input module 51. The location module 21 has at least two ultrasonic transducer 611, 613 for cooperating with an ultrasonic transducer 311 near the pen nib of the stylus 31 to locate the pen nib, the ultrasonic transducer 611, 613, 311 is not only a ultrasonic transmitter but also a ultrasonic receiver, in this embodiment, the ultrasonic transducer 311 in the stylus 31 is used as an ultrasonic transmitter for cooperating with the ultrasonic transducers 611, 613 which are used as ultrasonic receivers to locate the stylus 31. Furthermore, in order to locate more exactly, an infrared transducer 312 used as an infrared transmitter is arranged in the stylus 31 and an infrared transducer 612 used as an infrared receiver is arranged in the location module 21 to assist the ultrasonic location in locating the stylus 31.

When the stylus 31 writes on a display 411 of the display module 41, the transistor or the light touch switch is started, the script is taken down and displayed in the display 411, in this embodiment, the display 411 is a bi-stable display, such as a cholesterin LCD, when the power is off, the bi-stable display still displays the information, so it can be used as e-newspaper and do not consume power.

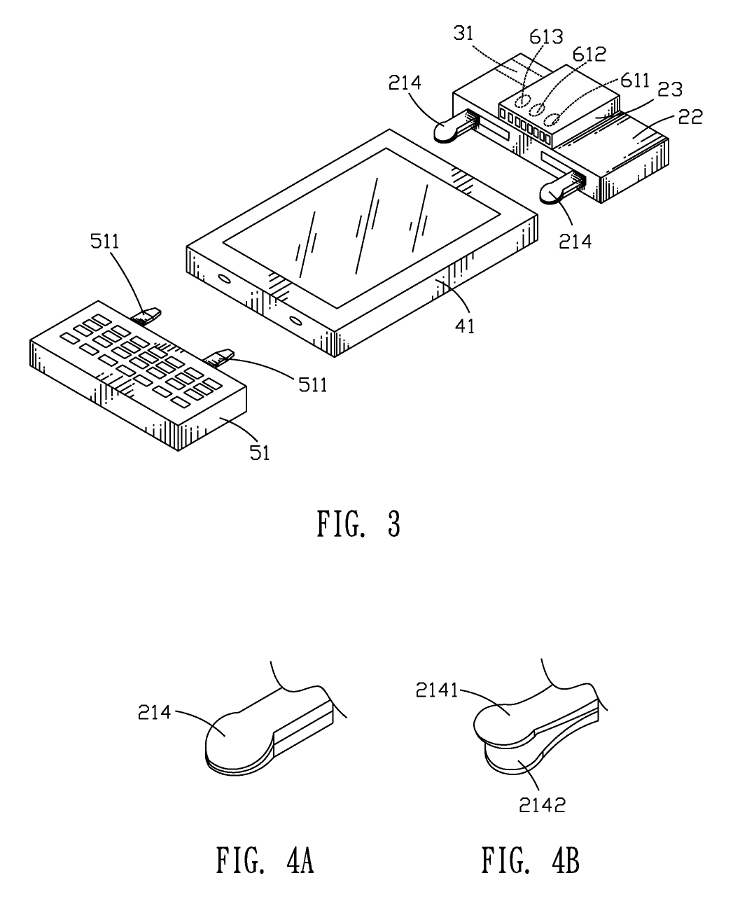

FIG. 3 shows the mobile electronic device when the location module 21 is separated from the display module 41. The location module 21 has a rectangular base 22 and a load portion 23 arranged on the base 22, the ultrasonic transducer 611, 613 and the infrared transducer 612 are located in the load portion 23. Two tenons 214 protrude towards the display module 41 from one side of the location module 21, the location module 21 is connected to the display module 41 by the tenons 214 wedging in the display module 41. When the location module 21 is separated from the display module 41, the tenons 214 rotate 90 degrees and then are received in the location module 21, the stylus 31 also can be received in the location module 21. Similarly, the keyboard input module 51 is also connected to the display module 41 by two tenons 511 wedging in the display module 41. Please refer to FIG. 4A, the tenon 214 has a protuberance at the front end for wedging in the corresponding recess of the display module 41. FIG. 4B shows another tenon 214 having two separating portions 2141, 2142, the separating portions 2141, 2142 clip papers therebetween.

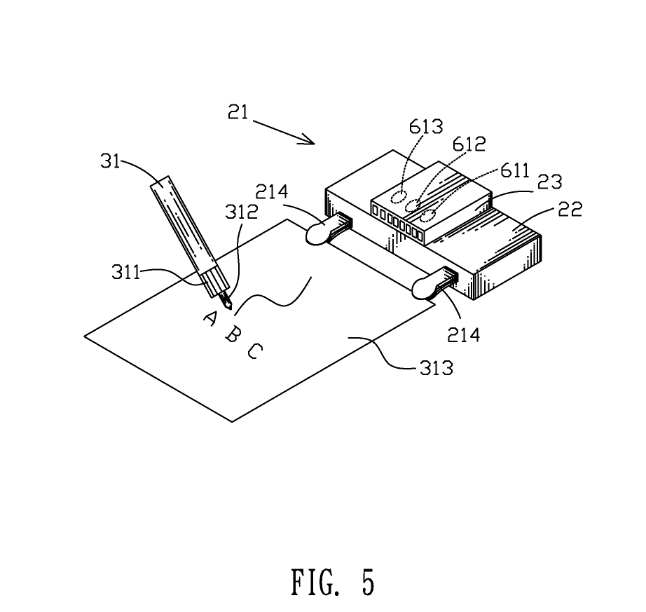

Referring to FIG. 5, the location module clip papers 313 by the tenons 214 shown in FIG. 4B, the stylus 31 writes on the paper 313, so the real script is taken on the paper 313, while the electronic script is stored in the Memory and transmitted by way of BlueTooth, WiFi, WiMax, GPRS and so on by input/output interface. Furthermore, the electronic script is identified by the technology of OCR (optical character recognition) and then sent as a short message, or an instant message, or an email through mobile network for communication.

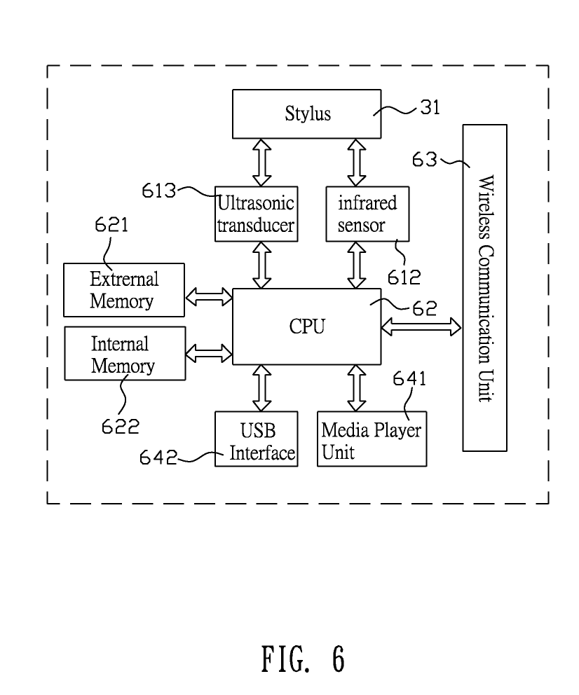

For further understanding of the present invention, please refer to FIG. 6, it is a block diagram schematically illustrating the location module 21. The location module 21 has a CPU 62, the two ultrasonic transducers 611, 613, the infrared transducer 612, an external memory 621, an internal memory 622 and an output communication unit such as a wireless communication unit 63 and a USB (Universal Series Bus) 642 all electrically connected to the CPU 62. The wireless communication unit 63 can be WiFi, WiMax, GPRS, BlueTooth, Edge and so on. The USB 642 is replaceable by other Data Bus. Firstly, the ultrasonic transducer 613 receives the ultrasonic signals transmitted from the infrared transducer 312 of the stylus 31, the infrared sensor 612 receives the infrared transmitted from the stylus 31, and then the CPU 62 detects the position of the stylus 31 in combination with the data stored in the internal memory 622. The location signal is transmitted outside through the USB 642 or the wireless communication unit 63, which is detailedly described hereinafter with various figures and embodiments. A media player unit 641 can be arranged in the location module 21 and electrically connected to the CPU 62 to acquire information from the media database and play the media files. The media player unit 641 is connected to a headset, a loud speaker or a display to play the media files through the wireless communication unit 63 or the USB 642, obviously, the media files can be played on the display module 41.

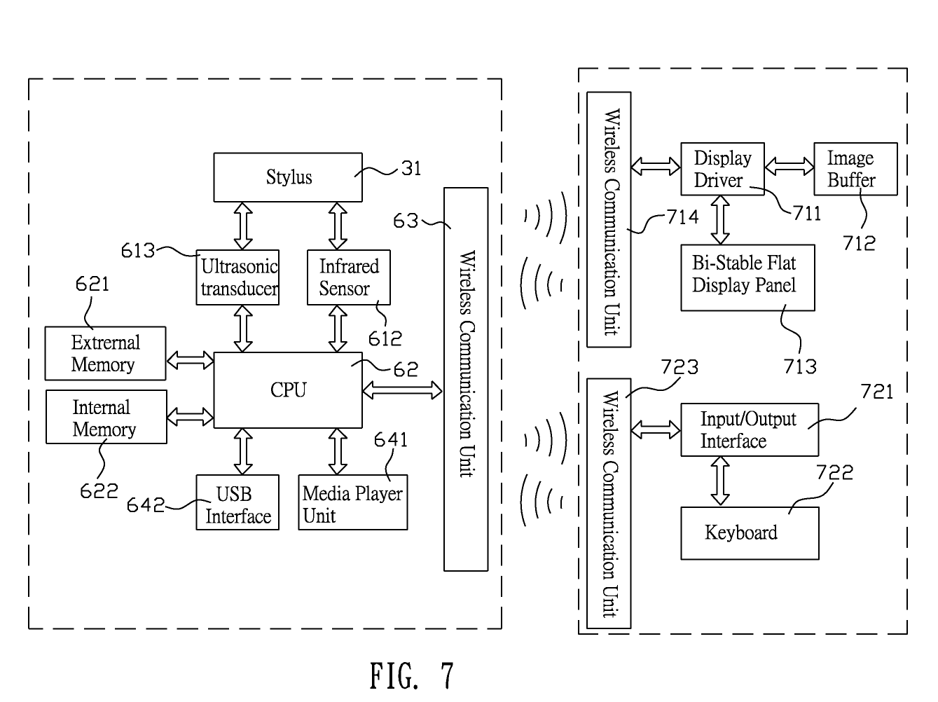

FIG. 7 is a block diagram schematically illustrating a bi-stable display 713 communicating with a wireless communication unit 63 of the location module 21 by a wireless communication unit 714 for transmitting image signal. The image signal is disposed by a display driver 711 and an image buffer 712 and then is displayed on the bi-stable display 713, meanwhile, the keyboard 722 inputs the characters through an input/output interface 721, a wireless communication unit 723 and the wireless communication unit 63 of the location module 21.

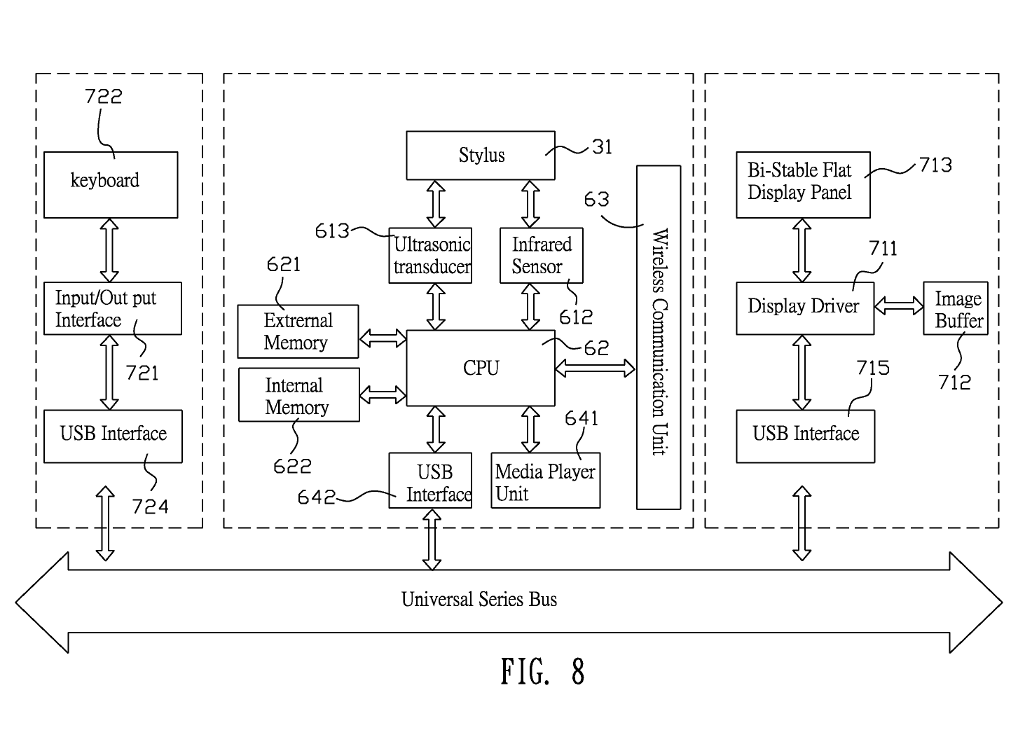

FIG. 8 is a block diagram schematically illustrating that the mobile electronic device of the present invention exchanges information by way of a database, in this embodiment, the database is a USB. The bi-stable display 713 transmits the image signal through a USB 715 and the USB 642 of the location module 21. The image signal is disposed by the display driver 711 and the image buffer 712 and then is displayed on the bi-stable display 713, meanwhile, the keyboard 722 inputs the characters through a USB 724 and the USB 642 of the location module 21.

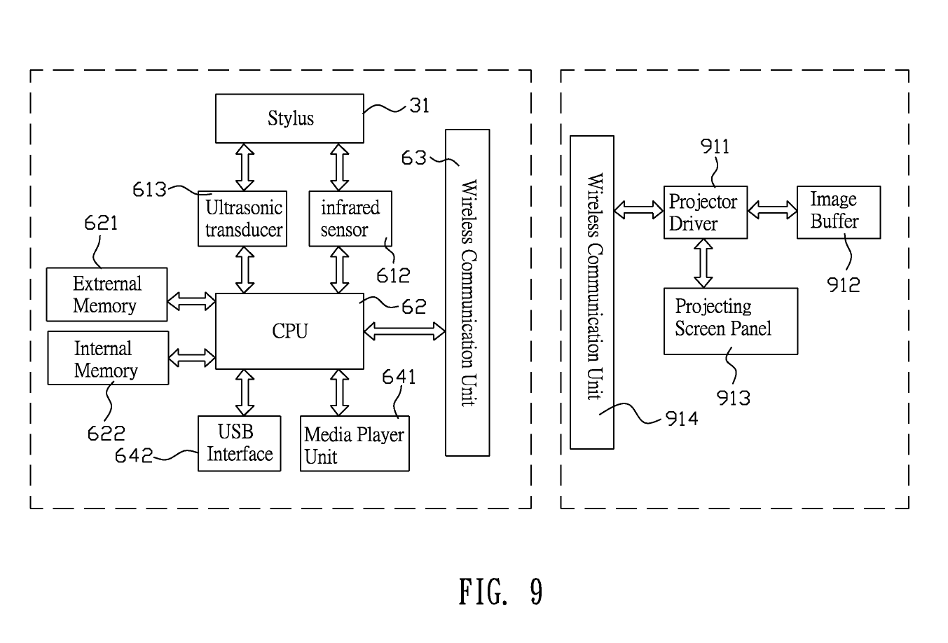

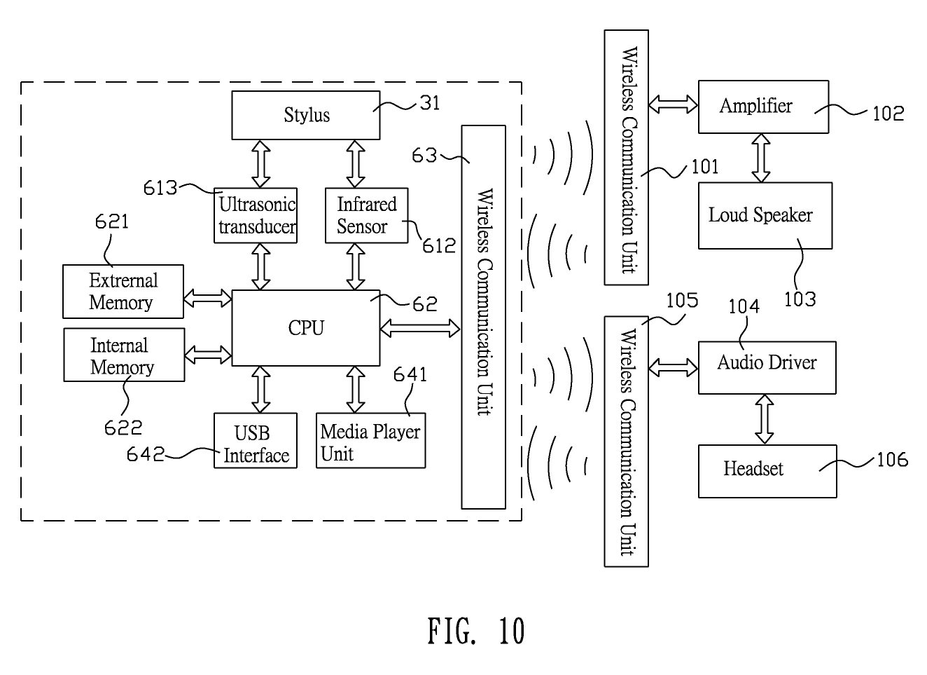

Though the display module 41 of the present invention in this embodiment is described as a bi-stable display, the location module 21 of the present invention also can be connected to an outer display, such as a TV set, an LCD, a projector, etc., which is described hereinafter through FIGS. 5-9 respectively. When the paper 313 is clipped in the tenon 214 of the mobile electronic device to form an electronic whiteboard, the stylus 31 writes on the paper 313, the location module 21 communicates with the display through the wireless communication unit 63 or the USB 642, in this embodiment, the location module 21 communicates with a projector through the wireless communication unit 63, firstly, the location module 21 transmits the script to a wireless communication unit 914 through the wireless communication unit 63, next, the script signal is disposed in a projector driver 911 and an image buffer 912 and then displayed on a projecting screen panel 913, lastly, the script is displayed on the screen of the projector.

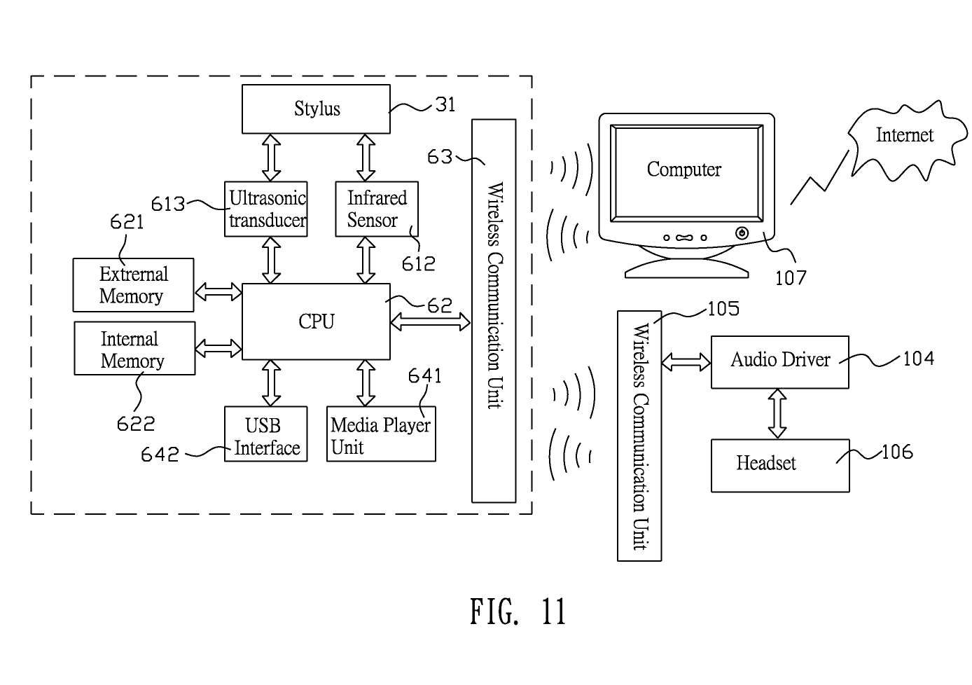

FIG. 10 is a block diagram schematically illustrating a media player unit 641 arranged in the location module 21 playing music. In this embodiment, the wireless communication unit 63, 101, 105 are BlueTooth units, when the BlueTooth units 63, 101, 105 communicate with each other, the sound signal is transmitted to an amplifier 102 and then drives a loud speaker 103 to play the music, similarly, the sound signal also can be transmitted to an audio driver 104 and then played by a headset 106, as described above, the sound can be played by the location module 21. As a result, as shown in FIG. 11, the BlueTooth unit 63 communicates with a computer 107 and the computer 107 communicates with Internet, so people can communicate with another people by way of Internet Telephony, such as Skype, MSN, Google Talk, SIP service, etc., through the headset utilized BlueTooth unit 63. Moreover, users can communicate with each other by transmitting the electronic script, or the electronic script is identified by the technology of OCR and then sent to other users by email.

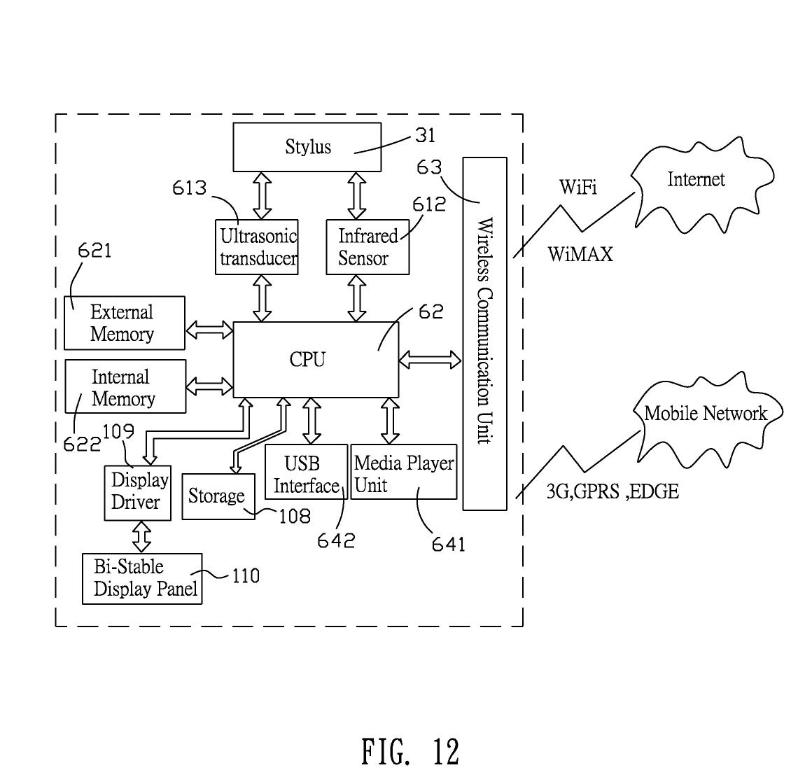

Then please refer to FIG. 12, a storage 108 is arranged in the location module 21, a display driver 109 drives a bi-stable display 110, the location module 21 communicates with Internet directly through the wireless communication unit 63 by way of WiFi or WiMax, so a computer is unnecessary in this embodiment. Moreover, when an Embedded Operation System is arranged in the Internal Memory 622, such as ROM, EPPROM, etc., then the storage 108 is also unnecessary. Furthermore, when the wireless communication unit 63 applies GPRS, or EDGE, or 3G communication treaty, the location module 21 can communicate with the Mobile Station and become a mobile communication device such as a mobile phone, thus become a Mobile Subscriber of mobile phone network, with the present invention, people can communicate with other people directly.

Similarly, the bi-stable display, such as a cholesterin LCD, an electrophoresis display, a miniature capsule electronic ink display, etc., can be connected to the location module 21 in wireless way or wire way (shown in FIG. 7 and FIG. 8) instead of being connected to the location module 21 directly.

As described above, the present invention realizes the communication between the location module, the display module, the far end network and the database in wireless or wire way, a bi-stable display which do not consume much power is used to become an e-book or an e-newspaper, or a projector is used to display the image received from the location module, so the present invention has various applications and is convenient for operating.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A mobile electronic device, comprising:
a stylus having an ultrasonic transducer near the pen nib thereof;
a location module, having a CPU, at least two ultrasonic transducers and at least one output communication unit all electrically connected to the CPU, the two ultrasonic transducers cooperating with the ultrasonic transducer of the stylus to locate the stylus, the location signal being disposed in the CPU and then being transmitted outside through the output communication unit; and
a bi-stable display module having a display driver, a bi-stable display, an image buffer and an input communication unit, the input communication unit receiving the location signal transmitted from the location module and then transmitting the location signal to the display driver, the location signal being disposed in the display driver and then stored in the image buffer or displayed on the bi-stable display.

2. The mobile electronic device as claimed in claim 1, wherein the location module has two output communication unit one of which is a wireless communication unit, the other is a Universal Series Bus, correspondingly, the bi-stable display has two input communication module one of which is a wireless communication unit, the other is a Universal Series Bus.

3. The mobile electronic device as claimed in claim 2, further comprising a keyboard input module separably connected to the bi-stable display module, the keyboard input module has a Universal Series Bus for electrically connected to the Universal Series Bus arranged in the location module.

4. The mobile electronic device as claimed in claim 1, wherein one side of the location module protrudes towards the display module to form at least one tenon, the location module is connected to the display module by the tenon wedging in the display module, the location module is separated from the bi-stable display module by the tenon separating from the display module.

5. The mobile electronic device as claimed in claim 4, wherein the tenon has a protuberance at the front end for wedging in a corresponding recess of the bi-stable display module.

6. The mobile electronic device as claimed in claim 1, wherein the location module has a media player unit electrically connected to the CPU therein.

7. The mobile electronic device as claimed in claim 1, wherein the stylus the location module and further comprises an infrared transducer respectively for assisting the ultrasonic location in locating the stylus.

8. A mobile electronic device, comprising:
a stylus having an ultrasonic transducer near the pen nib thereof;
a location module, having a CPU, at least two ultrasonic transducers and at least one output communication unit all electrically connected to the CPU, the two ultrasonic transducers cooperating with the ultrasonic transducer of the stylus to locate the stylus, the location signal being disposed in the CPU and then being transmitted outside through the output communication unit; and
a bi-stable display module having a display driver, a bi-stable display, and an input communication unit, the input communication unit receiving the location signal transmitted from the location module and then transmitting the location signal to the display driver, the location signal being disposed in the display driver and then displayed on the bi-stable display.

9. The mobile electronic device as claimed in claim 8, wherein the location module includes an external memory electrically connected to the CPU therein.

10. A mobile electronic device, comprising:
a stylus having an ultrasonic transducer near the pen nib thereof;
a location module, having a CPU, at least two ultrasonic transducers, a storage and a wireless communication unit all electrically connected to the CPU, the wireless communication unit applying GPRS, or EDGE, or 3G communication treaty therein, the two ultrasonic transducers cooperating with the ultrasonic transducer of the stylus to locate the stylus, the location signal being disposed in the CPU and then being transmitted outside through the wireless communication unit;
a bi-stable display module having a display driver, a bi-stable display, an image buffer and an input communication unit, the input communication unit receiving the location signal transmitted from the location module and then transmitting the location signal to the display driver, the location signal being disposed in the display driver and then stored in the image buffer or displayed on the bi-stable display.

11. The mobile electronic device as claimed in claim 10, wherein the storage is a hard disk.

12. The mobile electronic device as claimed in claim 10, wherein the storage can be instead by an embedded operation system arranged in an internal memory of the location module.
